(19) United States
(12) Patent Application Publication
(10) Pub. No.: US 2020/0254307 A1
(43) Pub. Date: Aug. 13, 2020

(54) METHOD FOR DETERMINING PERFORMANCE DATA WHEN RIDING A BICYCLE AND TWO-WHEEL COMPONENT

(71) Applicant: DT Swiss Inc., Grand Junction, CO (US)

(72) Inventors: Martin WALTHERT, Aarberg (CH); Simon HUGENTOBLER, Liebefeld (CH); Seamus MULLARKEY, Tann (CH); Jonas Gretar JONASSON, Thalwil (CH)

(21) Appl. No.: 16/785,284

(22) Filed: Feb. 7, 2020

(30) Foreign Application Priority Data
Feb. 9, 2019 (DE) 102019103231.8

(51) Int. Cl. A63B 24/00; G01M 9/00; G01S 19/01; G01L 19/00; G01C 22/00; G01P 3/00

(52) U.S. Cl. CPC A63B 24/0062; G01M 9/00; G01S 19/01; G01L 19/00; A63B 2220/40; G01P 3/00; A63B 2220/74; A63B 2220/73; A63B 2220/30; G01C 22/002

(57) ABSTRACT

A bicycle component and method of determining performance data by capturing and evaluating sensor data while riding an at least partially muscle-powered bicycle (100) on a road, having at least two sensors (20, 35), wherein air pressure signals (21) are captured by a barometric pressure sensor (20) and current gradient values (201) of the path (200) are derived. Track data are captured and a current speed value is captured, and performance data are obtained from the current gradient value (201) and the current speed.

The present invention relates to a two-wheeled vehicle component or bicycle component and a method of determining performance data by capturing and evaluating sensor data respectively data captured by sensors, while operating an at least partially muscle-powered two-wheeled vehicle on a path and in particular a street or road. Although the invention will now be described in respect of use with an at least partially muscle-powered bicycle, the method may also be used with solely muscle-powered or partially or entirely electrically operated bicycles.

The present invention may in particular be used in a system for measuring the aerodynamic drag coefficient (CdA) of a bicycle with a rider. Obtaining the aerodynamic drag coefficient for example of a bicycle with a rider requires a number of measurement values. It is for example significant to know the value of a current gradient.

These days for example the elevation position of bicycles tends to be obtained by means of a barometric pressure sensor. Alternately it is possible to capture an elevation position via a satellite system such as GPS or another satellite navigation system. A satellite system provides high accuracy of elevation determination. Several subsequent measurements allow to derive a gradient. The drawback thereof is that the elevation position shows at a relatively low resolution. This leads to very high inexactness when obtaining for example the gradient of a mountain or a hill. The result suffices for viewing during or following a tour but it does not for obtaining an aerodynamic drag coefficient of a useful quality.

Another option of determining the elevation or change in elevation is to use a barometric pressure sensor to derive a (relative) elevation from the air pressure signal. Barometric pressure sensors operate with a high resolution considerably better than that of satellite systems. A drawback of using barometric pressure sensors for capturing the ambient air pressure is that the measurement result may be distorted systematically or temporarily and accidentally, by changes in the weather, such as rising or falling air pressure, or by local disturbances, or for example by drifting sensors.

It is therefore the object of the present invention to provide a method of determining performance data by capturing and evaluating sensor data during riding, and a two-wheeled vehicle component with which to capture performance data during riding.

This object is solved by a method having the features of claim 1 and by a two-wheeled vehicle component having the features of claim 14. Preferred specific embodiments are the subjects of the subclaims. Further advantages and features of the present invention can be taken from the general description and the description of the exemplary embodiments.

A method according to the invention of determining performance data by capturing and in particular evaluating sensor data or data captured by sensors, while riding a bicycle that is at least partially muscle-powered on a path and in particular a street or road, is carried out employing at least two sensors. At least signals such as air pressure signals are captured, and the following steps are carried out in this or another useful sequence.
Capturing current (in particular characteristic) air pressure signals for the ambient pressure by means of at least one barometric pressure sensor;
Capturing track data and determining a current speed value of the bicycle;
Determining a current gradient value of the path from the captured air pressure signals and the captured track data
Obtaining performance data from the current gradient value and the current speed value.

The present invention has many advantages. A considerable advantage of the method according to the invention consists in that a speed value of the bicycle and a gradient value of the path is derived from the current air pressure signals and the track signals. Taking into account the current speed value of the bicycle and the current gradient value of the path, (characteristic) performance data are determined. Measuring with a barometric pressure sensor is fast and precise and may be performed very frequently. Even minute changes to the elevation may be captured.

Acceleration of the bicycle is preferably taken into account. Acceleration is in particular derived from the speed value. Acceleration may also be determined by a separate sensor.

The weight of the bicycle including the rider and his equipment may be determined and input first. It is also possible to obtain types of performance data which do not yet take into account the weight. Some applications may omit taking into account the weight.

Preferably a current measure of elevation is (in particular periodically) derived for the current elevation of the bicycle.

It is preferred to (periodically) obtain at least one current elevation signal by capturing data from a satellite system or a global navigation satellite system, in particular for the current elevation of the bicycle.

It is also preferred for a gyroscope and/or an inclination sensor to be comprised and used. An inclination sensor value may additionally be employed to enhance the accuracy of the gradient value.

A measure for an inclination of the path may also be derived from the elevation signal. The gradient value is preferably compared against the measure of the inclination of the path to verify plausibility and enhance the accuracy. This allows to recognize interference signals.

Preferably a current elevation value is (periodically) obtained from the current air pressure signal for the ambient pressure, taking into account the current elevation signal (for the current elevation of the bicycle).

To this end, preferably at least one measuring frequency is variably set for capturing signals (by means of a control device). Preferably at least one measuring frequency for capturing air pressure signals and/or a measuring frequency for capturing elevation signals is variably set by means of a control device.

It is possible to employ a current elevation signal from a satellite system for correcting the air pressure signal. Such correction preferably only takes place if, given a specific quantity of measurements, a specific deviation shows between a current measure of elevation obtained from the current air pressure signal, and the elevation signal from the satellite system. This allows to take into account weather influences and atmospheric conditions changing during the ride. These influences can be discounted and the accuracy may be increased.

It is particularly preferred for the measuring frequency for capturing measurement signals, such as air pressure signals and elevation signals, to be variable and to be actively adapted by means of the control device.

Preferably at least one measuring frequency is adapted by means of a control device provided locally on the bicycle component or the bicycle. This allows flexibility of varying at any time, the measuring frequency for measuring air pressure signals and/or elevation signals.

The measuring frequency or at least one measuring frequency can thus be adapted to current conditions or requirements anytime. For example, adaptation may be provided to be dependent on the state of the energy supply. As the energy supply drops beneath a threshold value, the frequency of measuring or capturing air pressure signals and/or elevation signals may be reduced to extend the operating time. In the case of previously known riding distances, the measuring frequency may be dynamically adapted to the riding distance or the remaining riding distance.

Increasing the measuring frequency is preferred if it is useful or necessary e.g. for high precision. The measuring frequency for measuring air pressure signals and/or the measuring frequency for measuring elevation signals may be reduced if it is sufficient for the desired accuracy of the current elevation value or any values computed therefrom. This allows for one, to enhance precision and for another, to also extend the operating time. Reducing the measuring frequency allows to save energy and thus to extend the operating time.

It is possible and preferred to separately adapt the measuring frequency for capturing air pressure signals and/or the measuring frequency for capturing elevation signals. Thus for example the energy demand for capturing elevation signals tends to be higher than the energy demand for capturing air pressure signals. Halving the measuring frequency for elevation signals thus reduces the power demand while extending the operating time.

Also possible and preferred is dynamic adaptation. Thus the measuring frequency for capturing elevation signals may be greatly reduced, if the elevation signal has varied little or not at all or constantly, over a number of measurements. In particular minor or no variations indicate a ride in the plane, so that the measuring frequency may be halved or quartered or reduced still further down to ⅕ or 1/10 or 1/20.

In other situations the measuring frequency may be increased, e.g. doubled. For example as an upward slope begins, or if the traveling speed is increased or is high.

On the whole the precision may be increased on the one hand and on the other hand, energy may be saved at other times so as to extend the operating time.

The invention is used in particular with at least partially or entirely muscle-powered two-wheeled vehicles and in particular bicycles. Therefore the term two-wheeled vehicle component may be continuously replaced by the term bicycle component. A two-wheeled vehicle and in particular a bicycle in the sense of the present invention preferably comprises two wheels on two different axles. In particular in use as intended the two wheels are disposed (at least substantially or entirely) in tandem.

Its use is possible and preferably provided in particular with so-called “Light Electric Vehicles” (LEV), meaning electric vehicles having two or four wheels driven by a battery, fuel cell or hybrid drive, generally weighing less than 100 kg and preferably less than 80 kg and particularly preferably less than 50 kg or 30 kg. Particularly preferably the invention is used for use in open-top two-wheeled vehicles or bicycles. These are roof-less, two-wheeled vehicles.

The sensor used for capturing a current air pressure signal is in particular a barometric pressure sensor.

Particularly preferably the or at least one measuring frequency is set on the basis of at least one current riding condition.

In particular is the measuring frequency set in dependence on the current riding conditions. When setting the measuring frequency, at least one parameter is in particular taken into account, which is taken from a group of parameters of the current riding conditions. The group of parameters of the current riding conditions comprises in particular, the orientation of the path to the horizontal such as the inclination, slope or ascend of the path, the traveling speed of the bicycle, the absolute elevation position of the bicycle, the humidity, density, and/or temperature of the ambient air, the local position (e.g. via GPS or the like), the value of the gravitational acceleration and the state of the energy supply, and more of these kinds of values. The traveling speed, the relative wind direction and the relative air speed relative to the bicycle component may also be comprised in the group of parameters. The parameters in particular encompass what are current values.

Particularly preferably at least one measuring frequency is dependent on the traveling speed and the inclination (slope and ascend) of the path. In particular at least one measuring frequency is dependent on the state of the energy supply.

Preferably the resolution of a measure of elevation and/or elevation value is at least higher than ⅓ or ½ the (native) resolution of the elevation signal. The resolution of a measure of elevation and/or elevation value is in particular higher than 1 m and in particular higher than 50 cm or higher than 25 cm or 10 cm or 5 cm.

Preferably a change of elevation is derived from the current air pressure signal and a reference signal of the air pressure. A reference signal of the air pressure may also be referred to as a reference air pressure signal.

A reference signal is preferably obtained or input at the start of a ride. The reference signal may also be derived from a transmitted air pressure signal. An air pressure signal may for example be transmitted via radio or through a network or an internet connection, and thereafter be (at least initially) used as a reference signal. It is also possible for a reference signal to be periodically received from a network or from the internet or via radio.

In particularly preferred specific embodiments the reference signal is periodically derived from at least one previously captured air pressure signal. Particularly preferably the reference signal is derived from a plurality of previously captured air pressure signals. A number of air pressure signals may for example be captured at a short time offset, whose time offset is so short that the position of the bicycle has virtually not (significantly) changed during measuring. Capturing a plurality of signals may reduce measurement value noises, so that a high quality signal is used as a reference signal. It is likewise possible to capture a plurality of signals for each of the air pressure signals as well, from which for example a mean value is averaged.

Preferably the current air pressure signal is captured periodically. The air pressure signal is preferably obtained from a plurality of measurement values picked up by the barometric pressure sensor. The measuring frequency of the measurement values picked up by the barometric pressure sensor is in particular higher than 50 Hz (1/s) and preferably higher than 250 Hz. Particularly preferably the measuring frequency of the measurement values picked up by the barometric pressure sensor is higher than 500 Hz or higher than 1 kHz or 5 kHz.

It is preferred for measurement values picked up by the barometric pressure sensor to be filtered and for an air pressure signal to be derived from the filtered measurement values.

Preferably an air pressure signal is derived from at least three and preferably at least five or ten measurement values picked up by the barometric pressure sensor.

In all the configurations it is preferred to capture at least one acceleration value.

It is possible and preferred for the current elevation signal to be interpolated. An extrapolation of elevation signals is likewise possible. It is also possible to place a curve through the last values and to estimate the next elevation signal accordingly.

Preferably a current gradient value of the path is derived. Computation of a current gradient value is in particular performed from the current elevation value and a (or multiple) elevation value(s) preceding in time, wherein the difference of the elevation values is divided by the time difference of the measurements. A gradient value is in particular computed by the current elevation value and the elevation value derived immediately before. A plausibility check may be done to discount any measurement values that are noisy, or adulterated by disturbances, in the further computations.

Preferably a reference signal is corrected if the current elevation value obtained (in particular from the current air pressure signal) differs from the current elevation signal by a predetermined amount. A predetermined measure may for example correspond to half or the whole (native) resolution of the satellite sensor and/or of the satellite system. This is to avoid a gliding and increasing difference of the elevation values from the current elevation signal. The advantage of the high measurement resolution of air pressure signals may be combined with the advantage of the high precision of elevation signals obtained with a satellite sensor.

Interference signals such as disturbances caused by passing vehicles or wind gusts are preferably filtered out. This is done by plausibility checks and by comparison against the previously captured values. A plausibility check is e.g. possible via the obtained gradient, the speed of the bicycle, and the acceleration. Although these interference signal may interfere with measuring the elevation, they are also relevant for determining the CdA and performance measurements, since they also influence the rider.

It is preferred that in situations where one sensor type provides, or can provide, e.g. only disturbed or no measurement values, such as a satellite sensor in a tunnel, values continue to be obtained, stored, and optionally displayed, e.g. including values obtained by estimating. The user may receive an indication that low accuracy or reliability may be given, by a symbol or a warning.

It is possible and preferred that at least one speed sensor for capturing the traveling speed and/or at least one power sensor is comprised. At least one speed sensor may for example be disposed on one of the wheels. A power sensor may for example be disposed in the bottom bracket or on the pedals or the pedal cranks or the rear wheel hub, all of which may be comprised as well.

Preferably a measure for the rolling resistance is also captured or estimated and/or computed.

In advantageous configurations at least one aerodynamic drag coefficient is derived. The aerodynamic drag coefficient may be (periodically) obtained in particular during the ride. This allows the rider to assume different positions and to observe the effects of each of the positions and postures on the air drag. Different bicycle parts and/or pieces of equipment such as helmets, suits, shoes etc. can thus be tested.

Preferably the frequency for capturing the elevation signals from the satellite system is higher than 1/40 Hz. Preferably the frequency is higher than 1/20 hertz and particularly preferably higher than 1/15 Hz, and it may e.g. be 0.1 Hz. Preferably the frequency for capturing the elevation signals from the satellite system is less than 50 Hz and in particular less than 1 Hz.

Preferably the frequency for capturing the air pressure signals by the barometric pressure sensor is higher than ⅕ Hz. Preferably the frequency is higher than 1 hertz and particularly preferably higher than 5 Hz and in particular less than 25 kHz or less than 10 kHz. In advantageous configurations the frequency is between 10 Hz and 2 kHz. The frequency is in particular around 50 hertz (+/−20%).

In particularly preferred configurations the frequency for capturing the air pressure signals by the barometric pressure sensor is (considerably) higher than the frequency for capturing the elevation signals from the satellite system. The ratio of the frequency of capturing the air pressure signals to the frequency of capturing the elevation signals is in particular higher than factor 2 and preferably higher than factor 4, and it may reach, or exceed, the value of 8 and in particular 10 or 100. Capturing the elevation signals from a satellite system tends to use more energy than does capturing and converting the air pressure signals of the barometric pressure sensor. This allows to save energy and to use the bicycle component for longer periods without having to exchange, or recharge, the battery.

Preferably the times of capturing the air pressure signal and the elevation signal for deriving an elevation value are matched to one another and/or synchronized. The time offset between capturing the signals is preferably shorter than ¼ or ⅛ of the (longer) periodic time (of both measurements) and/or smaller than a range offset of the bicycle during the ride of 10 m and preferably smaller than a range distance of 1 m. Preferably the frequency is selected or adapted such that the range distance is less than 50 cm. Still smaller values are also possible and preferred.

In all the configurations it is preferred to compensate drop-outs of the satellite signal e.g. with the air pressure signal, and optionally vice versa. For example in tunnels, where interference signals must also be taken into account. Or in (dense) forests, where trees might disturb the satellite signal. Or in cities, where high buildings may disturb signal reception.

Preferably the frequency for deriving an elevation value (and in particular for capturing the air pressure signals and/or the elevation signals) is dependent on the traveling speed of the bicycle. Preferably the frequency for deriving an elevation value increases with increasing traveling speed.

In advantageous specific embodiments the frequency for deriving an elevation value (and/or for capturing the air pressure signals and/or the elevation signals) is dependent on the gradient of the path and/or the acceleration. This allows to ensure sufficient accuracy.

A bicycle component according to the invention comprises a measuring device for capturing and evaluating sensor data respectively data captured by sensors during operation of an at least partially muscle-powered bicycle on a path and in particular a road, wherein the measuring device comprises at least two sensors or wherein at least two sensors are assigned to the measuring device. At least one barometric pressure sensor is comprised for capturing a (characteristic) current air pressure signal and at least one satellite sensor for deriving a current elevation signal from a satellite system. Furthermore the bicycle component comprises a control device and a computer, which are configured and set up to compute a (an improved or corrected) current elevation value from the (characteristic) current air pressure signal, taking into account the current elevation signal.

The bicycle component according to the invention also has many advantages since it enables improved accuracy.

Preferably the computer is configured and set up to compute a gradient value of the path. It is preferred for the bicycle component to comprise at least one acceleration sensor. The control device serves for controlling and may comprise the computer.

The invention allows an advantageous way of capturing improved data when riding a bicycle. This allows to obtain aerodynamic drag coefficients of the bicycle including the rider, even given different seated positions and seated postures and equipment parts.

Detection of the absolute elevation and also elevation changes during riding is better, since the air pressure signals of the barometric pressure sensor for capturing the absolute ambient pressure may be controlled by the periodically captured elevation signals from a satellite system. If required and in the case of certain deviations, corrections may be performed, so as to prevent increasing deviations of the sensor values.

Also, known elevation data may be input, or automatically transmitted, in (known) positions. For example at home or on the beach or in marked or known points such as on mountain passes.

Although the frequencies at which a current measure of elevation is captured from a current, characteristic air pressure signal for an ambient pressure and a current elevation signal obtained by capturing data from a satellite system, may be identical, they are preferably different.

The air drag is a significant force against which the bicycle rider must work. A higher air drag makes the bicycle rider employ more energy to maintain or even increase his speed. This is particularly important when riding racing bicycles in racing conditions. Then the bicycle riders must keep up their energy over long distances. Bicycle races may be won or lost within a few seconds.

Therefore, reducing air drag is important for reasons of energy efficiency. This is also important for partially or entirely driven electric bicycles where a lower air drag allows higher speeds and/or extended operational range and/or reduced battery size. Therefore, deriving an aerodynamic drag coefficient is very advantageous for improving the competitiveness and efficiency of a bicycle rider and his equipment.

Measuring the aerodynamic drag coefficient is highly dependent on the sensor data and particularly on the current gradient value.

The present invention allows to compute the current gradient value and gradient angle with high accuracy from changes of elevation. The change of elevation in turn is determined by changes of the ambient pressure, which is captured by at least one barometric pressure sensor.

The method according to the invention is not limited to use with an at least partially muscle-powered bicycle. The bicycle component according to the invention may be used with products other than bicycles.

The invention uses two or more different sensor types, for example to more precisely obtain the current elevation and/or the current gradient value or gradient angle of the road. Periodic recalibration of the barometric pressure sensor achieves higher precision over the entire measurement period.

Further advantages and features can be taken from the exemplary embodiments which will be discussed below with reference to the enclosed figures.

The figures show in:

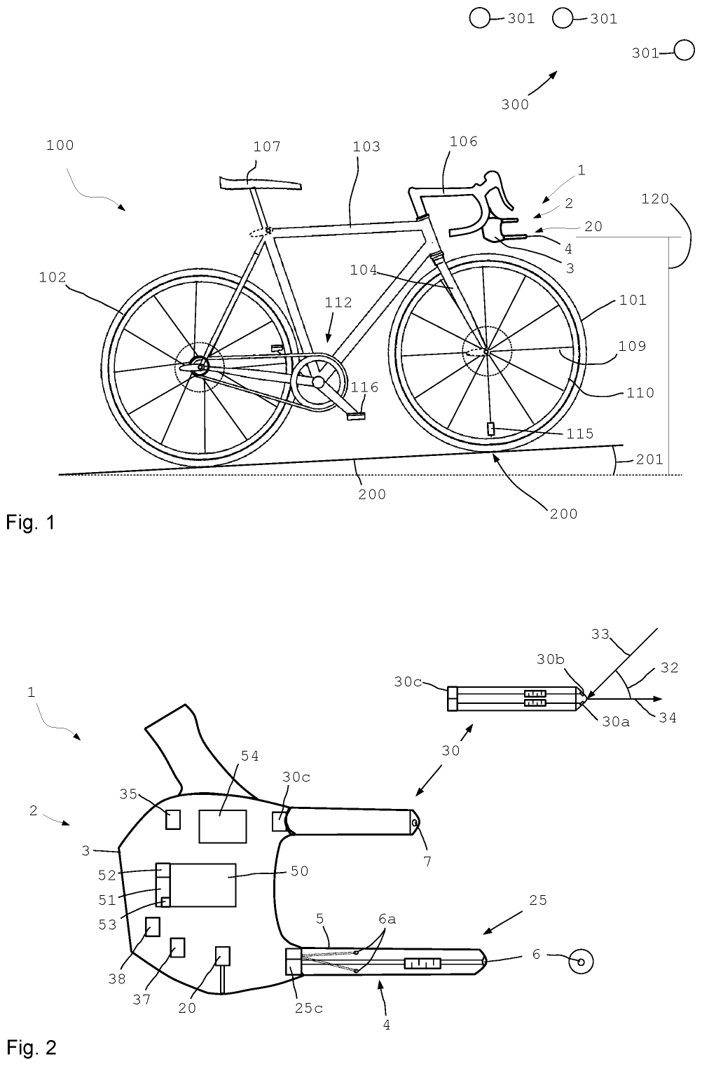

FIG. 1 a schematic side view of a racing bicycle on an ascending road including a bicycle component according to the invention;

FIG. 2 a bicycle component in a schematic side view;

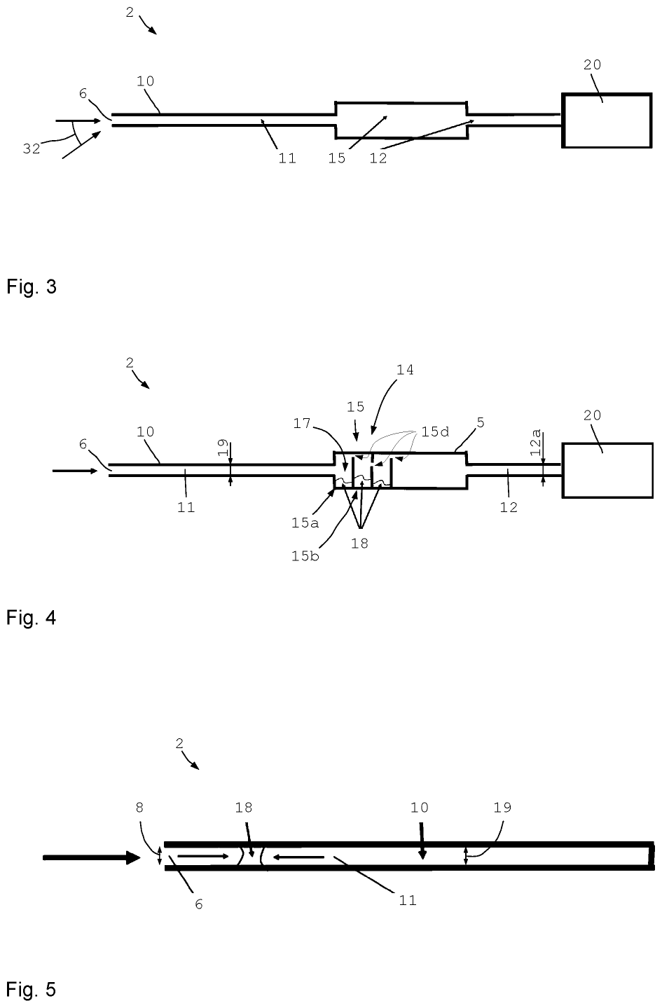

FIG. 3 a sectional diagrammatic drawing of a bicycle component;

FIG. 4 another sectional diagrammatic drawing of a bicycle component;

FIG. 5 a schematic detail of a bicycle component;

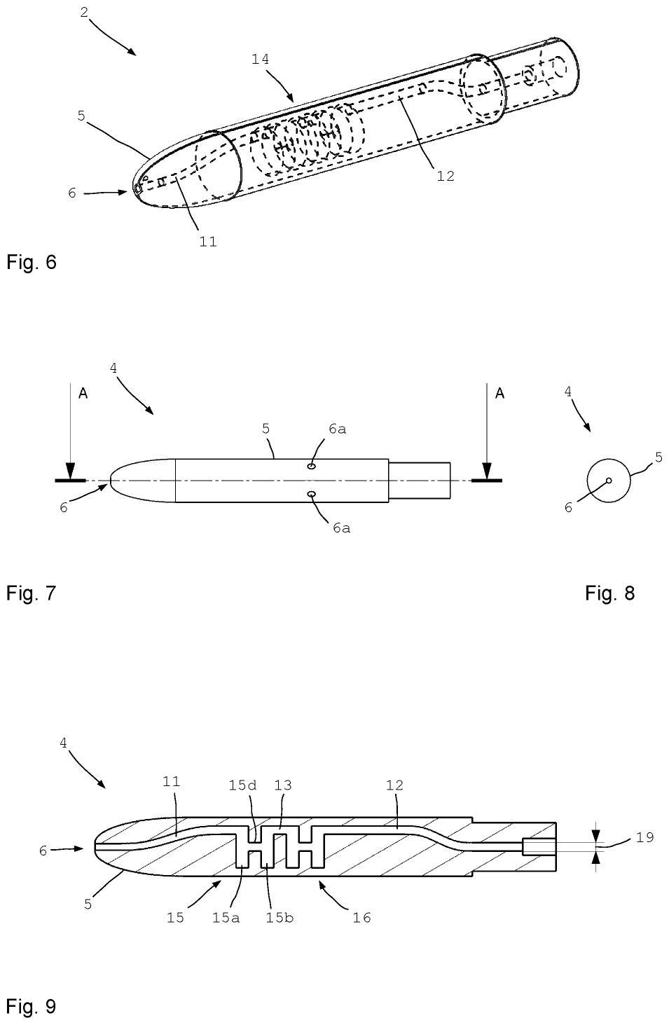

FIG. 6 a perspective illustration of a measuring probe of a bicycle component;

FIG. 7 the measuring probe according to FIG. 6 in a side view;

FIG. 8 a front view of FIG. 6;

FIG. 9 a section of FIG. 6;

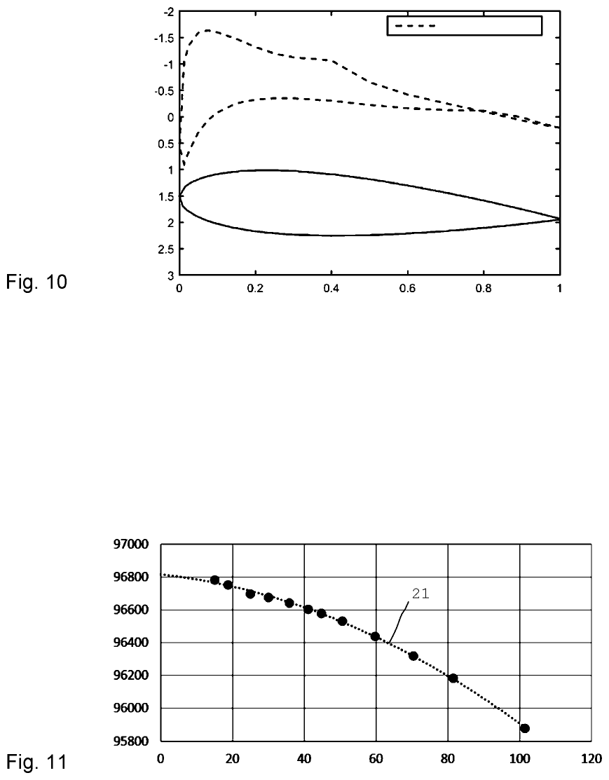

FIG. 10 an outline of the pressure coefficient on a surface of a body in the air stream;

FIG. 11 an outline of the absolute ambient pressure measured with a bicycle component over the air speed relative to the bicycle; and

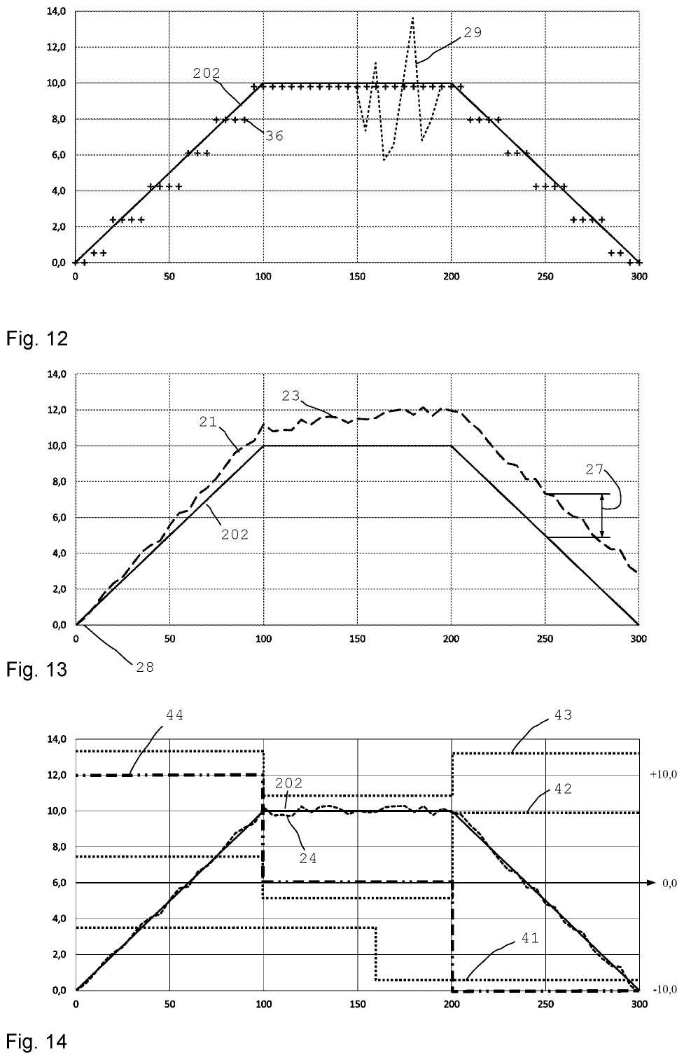

FIGS. 12 to 14 an elevation curve of a road over the track and values measured during riding on said track.

FIG. 1 illustrates a racing bicycle 100 wherein the invention may also be used in a mountainbike. The racing bicycle 100 comprises a front wheel 101 and a rear wheel 102. The two wheels 101, 102 are provided with spokes 109 and a rim 110. Conventional caliper brakes or other brakes such as disk brakes may be provided.

A bicycle 100 comprises a frame 103, a handlebar 106, a saddle 107 and a fork. A pedal crank 112 with pedals serves for driving. Optionally the pedal crank 112 and/or the wheels may be provided with an electrical auxiliary drive. The hubs of the wheels may be fastened to the frame e.g. by means of a through axle or a quick release.

The racing bicycle 100 illustrated in FIG. 1 travels uphill on a path or street 200. The gradient angle 201 indicates the present gradient. One or more speed sensors 115 serve to obtain the traveling speed of the racing bicycle 100 on the path 200. The speed may be obtained by way of spoke sensors or in the wheel itself and/or through satellite systems. Power or force sensors 116 at the pedals and/or pertaining sensors at the pedal crank and/or at the rear wheel hub serve to compute the driving power of the racing bicycle 100.

The bicycle component 1 with the measuring device 2 is directionally fastened to the handlebar 106 and/or the fork. The captured data can be evaluated, stored and processed in the bicycle component 1 or the measuring device 2 of the bicycle component 1 or in a separate (bicycle) computer.

The bicycle component 1 comprises a measuring device 2 and a housing 3 where one or more measuring probes 4 are disposed. The measuring probe 4 may be configured as a pitot tube and may capture a measure of the stagnation pressure at the front end of the measuring probe 4 or the probe body 5. An internal air guide allows to feed the total pressure to a barometric pressure sensor where it is captured. Taking into account the ambient pressure allows to derive the stagnation pressure. Preferably a differential pressure sensor is used for capturing a pressure difference between the total pressure at the front end and a lateral, local static pressure (local ambient pressure) on the measuring probe 4. It is also possible to use two absolute pressure transducers and to obtain their difference for computing the stagnation pressure.

FIG. 2 shows an enlarged illustration of the bicycle component 1 from FIG. 1 and schematically shows several components or parts of the bicycle component 1. The bicycle component 1 comprises a measuring device 2. The measuring probe 4 with the probe body 5 is disposed at the front end of the bicycle component 1 viewed in the traveling direction, to capture the stagnation pressure at the front end of the bicycle component 1 and thus near the front end of the bicycle 100. Positioning in the front region substantially avoids possible influences by further components of the racing bicycle 100.

At its front end the probe body 5 shows the outwardly opening 6. Through an air guide 10, which will be discussed in detail below, in the interior of the probe body 5, the opening 6 is connected with the schematically illustrated stagnation pressure sensor system 25. A front view is schematically illustrated on the right next to the bicycle component proper. The round probe body 5 with the central front opening 6 is identifiable.

The probe body 5 of the measuring probe 4 is elongated in shape and approximately cylindrical over a substantial part of its length. At least one hole 6a is configured spaced apart from the front end and presently in an approximately central section on the circumference. This hole 6a is connected with the stagnation pressure sensor system 25 on the side wall of the probe body 5. The central front opening 6 is likewise connected with the stagnation pressure sensor system 25.

The stagnation pressure sensor system 25 comprises a differential pressure sensor 25c, which captures a differential pressure between the openings 6 and 6a. Thus, a dynamic differential pressure is captured from which a stagnation pressure value or air pressure value is derived. A value for the local static pressure is captured via the openings 6a while the total pressure during the ride is captured through the opening 6. The differential pressure obtained with the differential pressure sensor 25c of the stagnation pressure sensor system 25 is a measure for the relative air speed streaming frontally onto the probe body.

A number of openings 6a are preferably evenly distributed over the circumference and interconnected inside the probe body 5 so that they capture an average static pressure. FIG. 2 exemplarily shows two openings 6a, each being disposed slightly above and approximately below the center line. The openings 6a may be interconnected in the longitudinal section of the openings 6a or may be connected with the differential pressure sensor 25c through separate ducts. Two or more and in particular three, four, five, six, seven or eight or more openings 6a may be (symmetrically) distributed over the circumference.

In the interior of the probe body 5 the indicated ducts are in particular configured in all the ducts so as to prevent water from penetrating up to the sensor.

The bicycle component 1 furthermore comprises a barometric pressure sensor 20 for capturing the ambient pressure. The barometric pressure sensor 20 for capturing the ambient pressure may be disposed in a number of positions of the measuring device 2. At any rate the barometric pressure sensor 20 should not also capture the total pressure which is captured by the stagnation pressure sensor 25 at the foremost tip of the measuring device 2.

For capturing the ambient pressure, the barometric pressure sensor 20 (also referred to as absolute pressure transducer) may for example be disposed inside the housing 3, specifically in a lower region of the housing 3 or in the rear region of the housing 3. It is also possible for the barometric pressure sensor 20 for capturing the ambient pressure to be disposed on a side surface or at the bottom face of the housing 3 or to include an inlet surface. At any rate the barometric pressure sensor 20 captures an air pressure signal 21 for the ambient pressure but not for some other pressure which might lie between the total pressure and the ambient pressure.

The bicycle component 1 illustrated in FIG. 2 furthermore comprises a satellite sensor 35 with which signals can be received from a satellite system 300 or its satellite 301 (see FIG. 1) to derive an elevation signal 36 in a known manner (FIG. 12). A humidity and/or temperature sensor 37 may be provided for determining the air humidity and/or air temperature, and may also be used for computing the air density of the ambient air. An acceleration sensor 38 serves to capture the accelerations of the racing bicycle 100.

By means of a computer 50 comprising a memory 51 and a data interface and in particular a network interface 52 the captured data may be processed, stored, and optionally transmitted to remote stations. The data interface may also comprise an antenna for receiving and/or emitting signals. Data can thus be optionally radio-transmitted.

The power source 54 may be a battery or an accumulator or another energy storage device to provide the energy required for the sensors, the memory and the computer. Energy supply through the bicycle is also conceivable.

A yaw sensor 30 comprises a differential pressure sensor 30c for capturing the differential pressure at the two openings 30a and 30b disposed at the front end of the yaw angle probe. The yaw angle probe is configured at its front end with two surfaces angled relative to one another (in particular perpendicular to the ground) and presently oriented at an angle of 90° to one another, and comprises the two openings 30a and 30b. A yaw angle 32 is derived from the measurement values.

The yaw sensor comprises a probe body similar to that of the stagnation pressure sensor system 25. Two separate air guides are configured in the interior of the probe body of the yaw sensor 30. The front tip is provided with two openings 30a, 30b at angles relative to one another, in particular connected with a differential pressure sensor 30c or separate pressure sensors to derive a differential pressure.

To facilitate overview, the half of FIG. 2 on the right shows a top view of the probe body of the yaw sensor 30 from which it can be seen that the openings 30a, 30b of the differential pressure sensor 30c are oriented at angles to one another.

Thus it is possible to obtain from the traveling speed 34 and the captured values, the wind direction and the wind speed 33 relative to the movements of the bicycle 100. Said wind direction and wind speed 33 correspond to the wind blast to which the rider is exposed at the yaw angle 32.

It is also possible to provide two or optionally more surfaces on which to measure the air pressure disposed e.g. at angles to one another to derive a yaw angle 32 from the differences between the measurement values.

FIGS. 3 to 5 are schematic illustrations of a bicycle component 1 respectively a measuring device 2 with a measuring probe 4. FIG. 3 shows a simple example of a measuring probe 4 including a graphic illustration of one of the air guides 10.

For the sake of clarity, only one air guide 10 each is shown although the yaw sensor 25 or the stagnation pressure sensor system 30 for capturing the stagnation pressure preferably each comprise differential pressure sensors and two or more separate air guides 10. Various air guides 10 are separate from one another inside of a probe body, comprising separate chambers 15 and/or chamber sections and optionally partition walls 15c to prevent water and/or dirt from entering up to the pressure sensor or differential pressure sensor.

At the front end of the probe body 5 the outwardly opening 6 is formed, which is followed by the air guide 10 and firstly, the air duct 11 as a supply duct. The air duct 11 extends up to the chamber 15 which provides a takeup space for any entered water. In a preferred configuration a typical diameter 19 of the air duct 11 is approximately 1 mm (+/−20%). The narrow diameter already largely prohibits the entry of water.

The rear end of the chamber 15 is followed by the air duct 12 that is configured as a sensor duct and extends up to the barometric pressure sensor 20. The typical diameter 12a of the sensor duct 12 is also approximately 1 mm (+/−20%) in a preferred configuration. The structure of the air guide 10 and the narrow diameter of the air and sensor ducts ensure reliable protection of the barometric pressure sensor 20 against penetrating water.

Another contribution to protection against penetrating water is the fact that the outer opening 6 of the air duct 11 shows a dimension or diameter 8 (which is smaller still than the diameter of the air duct 11). The diameter 8 is about 20% smaller than the typical diameter 19 of the air duct 11. An outer opening 8, that is smaller still, achieves a still better protection against penetrating water.

This allows to omit thermal measures such as heating the probe body 5. The interior remains largely free from water in operation. However, at least in the region of the probe body 5 the bicycle should not be cleaned by means of a high pressure cleaner.

Firstly the takeup space formed in the chamber 15 would have to fill up with water before water can enter the sensor duct 12. Due to the narrow dimensions and the water's surface tension any entering water forms a plug that tightly closes the duct and thus entraps the air volume present behind in the sensor duct 12. For water to penetrate further into the sensor duct 12 the entrapped air volume must be compressed so that a counterforce acts against penetrating water. In this way, water is largely prevented from penetrating up to the barometric pressure sensor 20.

The sensors 25, 30 may be adapted or configured similarly to the illustration in FIGS. 3 to 9.

FIG. 4 shows a variant where the inner chamber 15 is subdivided into a number of chamber sections 15a, 15b etc. To this end, partition walls 15c are provided subdividing the chamber 15 in chamber sections.

The chamber sections 15a, 15b are each provided with a takeup space 17 for collecting any penetrating water 18.

The partition walls 14 of the chamber 15 are provided with connecting openings 15d which connect the chamber sections 15a, 15b etc. successively and with one another (like a strand of pearls). The connecting openings are disposed spaced apart from the bottom of the pertaining chambers or chamber sections so as to provide suitable takeup spaces. The partition walls show connecting openings disposed so that they are not aligned but disposed laterally and/or vertically offset. Preferably each of the connecting openings is disposed spaced apart from the bottom of the pertaining takeup space.

On the whole this provides two or more interconnected chambers or chamber sections and with the pertaining air guide in-between, a labyrinth seal 14 which is a particularly reliable protection of the barometric pressure sensor 20 against penetrating water. For maintenance work or following each trip the air guide may be completely or partially cleaned. The measuring probe 4 may for example be demounted and flushed and dried and/or purged by (in particular oil-free) compressed air.

FIG. 5 shows a section of an air duct 11, 12 or 13, with a water droplet 18 exemplarily inserted in the air duct. The interior of the air ducts shows a diameter or cross section 19. The diameter 19 is in particular between 0.5 mm and 2 mm. In this specific example the clear diameter 19 is 1 mm. The outer opening 6 shows a dimension 8 which is preferably smaller than the clear diameter 19. The diameter 8 of the outer opening is preferably 0.8 mm.

The dimensions 8 and 19 are matched to one another and to the properties of water so that any penetrating water forms a water plug 18 in the interior of an air duct, as is shown in FIG. 5. The plug can enter into the duct only far enough for establishing a balance of the force generated by the compressed air volume and the force caused by the total pressure. The smaller diameters considerably contribute to sealing.

The FIGS. 6 to 9 illustrate a more concrete exemplary embodiment of the measuring probe 4 including a probe body 5. FIG. 6 shows a perspective illustration with one of the air guides 10 drawn in broken lines in the interior of the probe body 5 to provide a schematic overview. The front end shows the outwardly opening 6 at the tip of the probe body 5. The supply duct 11 follows as an air duct. In a central region a labyrinth seal 14 is comprised following in the rear region of the sensor duct 12 as an air duct.

FIG. 7 shows a side view and FIG. 8, section A-A from FIG. 7. FIG. 7 shows two of the total of e.g. four openings 6a (alternately, three or five or six or more openings are also conceivable) on the lateral circumference of the probe body 5, through which the static pressure is absorbed. The rear end of the probe body 5 then preferably shows a differential pressure sensor which captures a differential pressure of the total pressure and the local static pressure averaged over the circumference of the probe body 5 (ambient pressure locally averaged over the circumference of the probe body). It is also possible to employ two separate barometric pressure sensors used for determining the stagnation pressure.

FIG. 8 shows the opening 6 at the front tip.

FIG. 9 shows a cross section of the probe body 5 where it can be seen that the air guide 10 extends in the interior of the probe body 5 and presently comprises two chambers 15, 16, each showing chamber sections 15a and 15b, thus a total of four chambers (chamber sections). Each of the chambers 15, 16 is approximately “H” shaped in cross section with the supply provided through the supply duct 11 at the top end of the “H”. The connections with the second chamber 16 and the sensor duct 12 each also start at the top end of the chambers 15, 16. The chamber sections 15a, 15b are interconnected in a middle to top region via a connecting opening 15d. In this case the connecting opening 15d may also be referred to as an intermediate duct. The construction allows to use the lower legs of the “H”-shaped chambers 15, 16 as takeup spaces for any penetrating water 18.

The yaw sensor 30 is structured accordingly, comprising a probe body showing two openings and two air guides and preferably a differential pressure sensor 30c or two pressure sensors for obtaining a value of the differential pressure.

FIG. 10 shows a diagram with the pressure distribution around the surface of an object, while air is streaming onto the object from the front. FIG. 10 shows a cross section of an aircraft wing but basically, the pressure onto a surface depends on the angle of incidence and the properties of the object in other objects as well. While this object is drawn in a solid line, broken lines show the pressure coefficient which is representative of the pressure acting locally on the surface of the object.

FIG. 10 shows what is known per se, that the local pressure onto the surface of an object is dependent on the position on the surface of the object. Thus, the local pressure may be higher or lower than the normal, inactive ambient pressure (and further also depends on the air speed).

The dependence on the position is a problem if a vehicle moving relative to the ambient air—such as a bicycle—is to capture the ambient pressure. Even the interior of an object does not show the normal ambient pressure but the pressure is influenced by the traveling speed, the wind speed, the wind direction and also by the structure of the object.

If an aerodynamic drag coefficient of a bicycle is to be obtained, the sensor values required must be captured as precisely as possible. It is a great advantage if the gradient of a path and/or also the wind direction are captured as precisely as possible.

FIG. 11 exemplarily shows the “ambient pressure” measured directly with the barometric pressure sensor 20 by means of a bicycle component 1, over the air speed respectively the speed of the bicycle relative to the wind. The pressure is plotted in Newton per square meter (N/m² or Pa) over the speed in kilometers per hour. This specific case shows that the curve of the air pressure signals 21, measured at actually the same ambient pressure, strongly depends on the relative speed. With the air speed increasing, the measured air pressure signal 21 decreases. The difference in the illustrated speed range of 0 to 100 km/h is approximately 10 mbar or 1000 Pa.

The concrete curve depends on the arrangement of the barometric pressure sensor for measuring the ambient pressure, on the precise configuration of the measuring device respectively the bicycle component 1 and also on the wind direction. The effect cannot be generally avoided, independently of a selected position. Even if, as in this case, the barometric pressure sensor 20 for the ambient pressure is disposed inside the housing 3, the relative wind blast and relative direction of the air may impair the measuring quality. Dynamic effects may show, which increase or decrease the measured value. The air may stagnate in front of the sensor inlet or Bernoulli's theorem may show a measured pressure value 21 that is lower than the true ambient pressure.

The bicycle component 1 comprises in the computer memory 51, calibration data 53 which allow, based on measurement data or empirical data, to correct the air pressure signal 21 first captured by a barometric pressure sensor 20. Using the stagnation pressure values 26 captured with the stagnation pressure sensor system 25 is most advantageous. The result may be further improved, taking into account the yaw angle 32 captured with the yaw sensor 30.

This enables considerable improvement to the determination of the current elevation of the racing bicycle 100, and the gradient or the gradient angle 201 of a path 200 can be derived at considerably improved accuracy.

Since the inclination angle or the gradient or the slope of a path considerably influences the driving power required, an aerodynamic drag coefficient can thus be determined at considerably improved accuracy. A negative gradient tends to be called slope. In a slope the aerodynamic drag coefficient also exerts a big influence.

Furthermore the rolling resistance also influences the power required. To this end, further measurement values may be captured and analysed, or values captured previously are used. The rolling resistance is influenced by the tires used, the tire pressure, the weight of the bicycle and of the rider and the road condition, and may be obtained, computed, and/or estimated.

Data may be captured and evaluated to obtain pertaining calibration data 53 either in a wind tunnel or on suitable roads, given suitable ambient and wind conditions. The calibration data 53 may then be used in normal operation to increase the accuracy of the measurement results and the derived values. The calibration data 53 for the calibrating matrix is derived either from tests in the wind tunnel or from road tests with no variations of elevation in one range of air speeds and yaw angles.

The FIGS. 12 to 14 show the elevation curve of a path 200 over the track and values measured and derived during riding on said track.

In FIG. 12 the solid line shows the actual elevation curve 202 of the path 200 in meters (relative to the starting point) over the illustrated length in meters. Cross marks indicate single measuring points obtained and recorded during the ride over the illustrated track. The inserted measurement values are elevation signals 36 obtained by a satellite sensor 35.

For this purpose for example a GPS sensor or another satellite sensor 35 of a global navigation satellite system (GNSS) may be used. Also possible are systems using pseudosatellites providing a local satellite system and enabling triangulation of the elevation and/or position.

One can clearly see the high accuracy of the satellite sensor 35 and the elevation signals 36. One can also directly recognize that the resolution of the elevation signals 36 of the satellite sensor 35 is comparatively coarse. Elevation differences of just under 2 m are recognized. A resolution of 2 m is not sufficient for computing a gradient for determining an aerodynamic drag coefficient when operating a bicycle.

Therefore, using only satellite sensors 35 for obtaining a local gradient does not yield satisfactory results for example if an aerodynamic drag coefficient is to be computed therefrom. An interpolation between each of the measurement values does not provide the required accuracy either since the elevation curves of many paths considerably differ from the particularly simple test track shown. Thus the gradient may considerably change locally already over one meter or over a few meters.

FIG. 12 additionally shows in a broken line the curve of the measured ambient pressure during a disruptive event. These kinds of interference signals 29 may appear due to a passing vehicle and in particular a passing truck. Then the measured ambient pressure and the elevation computed therefrom considerably deviates from the true elevation. These events may be discounted through internal filtering. Preceding and following values are captured and taken into account and offset against the elevation determination through GPS. The typical curve with alternating pressure peaks and pressure minima facilitates filtering. Filtering also allows to prevent miscalculation of the wind direction and wind speed.

FIG. 13 shows the same track as does FIG. 12 wherein on the one hand, the actual elevation curve 202 of the test track is plotted and on the other hand, an elevation profile derived from an air pressure signal 21 of a barometric pressure sensor 20.

Initially a reference value 28 is captured which is then used for determining an elevation difference. It can be seen that as measuring begins, the curve measured by the barometric pressure sensors shows a close match with the actual elevation curve 202. Around the middle the difference in elevation is already nearly 2 m at the value 23.

As the track continues, the elevation curve measured with the barometric pressure sensor 20 shows a systematic offset or divergence versus the actual elevation curve 202. The reason is that the barometric pressure sensor 20 does not capture the actual elevation but a measure of the ambient pressure. Although the absolute ambient pressure also depends on the elevation, it may vary e.g. due to the weather. Now if the air pressure drops during the ride on the track or if the air pressure rises, then the values so determined may diverge. This is shown exemplarily by the value 27. Again the result is that the values are not sufficiently precise for obtaining a high quality, aerodynamic drag coefficient. For this, a higher accuracy of capturing the elevation is useful.

Finally, FIG. 14 in turn shows on the one hand, the actual elevation curve 202 of the test track and on the other hand, a curve of the elevation values 24 corrected via the various sensors respectively the measurement results of the various sensors.

To this end the air pressure signals 21 of the barometric pressure sensor 20 disposed in the interior of the housing 3 of the measuring device 2 are corrected according to the calibration data 52, by way of the stagnation pressure values 26 captured by the stagnation pressure sensor system 25 and the yaw angle values 31 captured by the yaw sensor 30, according to the basic principle of the illustration in FIG. 11, to obtain a largely correct measure of the current elevation value 24.

Moreover, in addition to capturing the air pressure signals 21, the satellite sensor 35 is also employed for determining elevation measures. At periodic intervals the high-precision satellite sensor 35 is employed to obtain a comparison value. If the elevation value 24 obtained by way of the various barometric pressure sensors 20, 25 and 30 significantly deviates from the elevation signal 36 of the satellite sensor 35, a new reference signal 28 is derived so that an accurately corrected elevation value 24 ensues with the pertaining air pressure signal 21. To avoid recalibration owing to noisy measurement values, corrections only take place if differences show over a significant period of time.

This method combines the advantages of the high accuracy of satellite sensors 35 with the advantages of the high resolution of barometric pressure sensors 21. At the same time the drawbacks of the coarse resolution of satellite sensors 35 and of the conceivable air pressure fluctuations from barometric pressure sensors 20 are avoided. As can be seen in FIG. 14, the result is high congruence of the effective curve of the elevation values 24 with the actual elevation curve 202 of the test track.

A (first) reference signal 28 may for example be input or captured at the start of a ride or when the elevation is known. Differencing of the air pressure signal 21 during riding and the reference signal 28 allows to obtain a measure of the current elevation. The reference signal 28 may firstly be obtained by obtaining an initial air pressure signal 21 which is used as a reference signal 28 for following measurements. The pertaining reference signal 28 may also be input or captured by the satellite sensor 35. During the ride the reference signal 28 may be updated periodically and at irregular time intervals.

Corrections of the reference signal 28 used for computing a measure of elevation 23 may be carried out for example if the sum total of the deviations between the elevation signals 36 of the satellite sensor 35 and the obtained elevation values 24 exceeds a specified measure or a specified threshold over a given time period. For example a mean value may be computed over a specific distance or after a specific time period, which is then used for comparison.

Elevation signals 36 are preferably measured between approximately 20 and 30 times per second and approximately 3 to 5 times per minute, in particular at a frequency of approximately 0.1 Hz. The frequency at which a current measure of elevation is captured from a current, characteristic air pressure signal for the ambient pressure is preferably higher and is in particular between 0.1 Hz and 1 kHz and preferably between 1 Hz and 100 Hz, particularly preferably approximately 50 Hz.

Particularly preferably the ratio of the measuring frequency of the air pressure signal 21 for the ambient pressure to the measuring frequency of an elevation signal 36 is larger than 10 and in particular larger than 100 and preferably smaller than 5000. This allows to achieve a high measure of accuracy while energy demand remains low.

FIG. 14 additionally illustrates three curves 41, 42 and 43 of the measuring frequencies. The measuring frequency for capturing the signals and in particular capturing the elevation signals or capturing the air pressure signals is dependent on the currently prevailing riding conditions and may be adjusted by means of the control device 40 and modified as needed. Thus the measuring frequency is set higher in particular in gradients and particularly preferably in slopes, than on straight tracks. The curves 41 to 43 each show the measuring frequency over the distance and they are shown vertically offset for better clarity, to illustrate each curve separately.

The first measuring curve 41 shows an example of a basically constant measuring frequency, where the state of the energy supply drops beneath a threshold approximately in the middle of the distance. Then, energy saving measures are initiated and the measuring frequency is clearly reduced. It is possible that at the reduced level the measuring frequency is still varied in dependence on the current riding conditions, for example it increases as the speed increases or in the case of gradients or slopes. In the plane the measuring frequency can be reduced still further.

The second measuring curve 42 shows a control variant where an increased measuring frequency is set in the region of the first gradient. As the middle plateau is reached, the measuring frequency is considerably reduced in what is now a plane level (e. g. factor ½). As a slope begins, the measuring frequency is greatly increased so as to achieve a very high precision for the higher riding speed downhill.

The third measuring curve 43 shows an example where in the region of the inclinations of the path (gradient/slope) the measuring frequency is increased, while the measuring frequency is reduced in the plane. This achieves increased precision in the region of the inclinations and energy demand is reduced in the plane. The curves 41 to 43 may in particular show not only the measuring frequency over the track but may also show curves of the measuring frequency over the riding time.

The schematically shown curves 41 to 43 show the measuring frequency over the track for a constant riding speed. The curves bend accordingly in the case of different riding speeds.

Preferably the measuring curves 41 to 43 each show identical measuring frequencies at the start, at the time 0. The absolute elevation is shown at an offset to better distinguish the curves graphically.

Furthermore, FIG. 14 shows the gradient curve 44 over the measuring distance in a dash-dotted line. At the start the curve of the gradient shows a constant level over the first third of the measuring distance. The gradient shows a value (scale on the right) of +10.0. In the second third in the plane the gradient is 0.0, and in the last third there is a slope with a gradient of −10.0. A gradient value 201 may be derived through the periodically captured air pressure signals 21 and the associated track data. To this end the data are first averaged and filtered.

The known weight of the bicycle and the rider allow to derive performance data from the current gradient value and the current speed value. It is taken into account whether and how the bicycle is accelerated.

Taking into account the input performance e.g. via force sensors on the pedals or torque sensors in suitable positions, all of the data allows conclusions about the currently prevailing aerodynamic drag. This assists the rider in taking, and maintaining, an optimal position during riding, since the relevant values are periodically re-captured and displayed. Computation is in particular done at a frequency of a minimum of 5 times per minute, preferably at least 20 times per minute. Frequencies of 0.5 Hz or 1 Hz or 10 Hz or more are likewise conceivable.

On the whole an advantageous bicycle component and an advantageous method are disclosed which enable improved options for measuring data in a bicycle. Depending on the positioning of a barometric pressure sensor for obtaining the absolute ambient pressure, the measurement result is influenced by the speed of the bicycle, the wind speed and the wind direction, and can thus provide results which are firstly imprecise. If the stagnation pressure is measured using for example barometric pressure sensors with a pitot tube open to the front in the traveling direction, a total pressure will ensue which depends on the absolutely prevailing air pressure in the ambience and on the traveling speed. This pressure signal is not alone sufficient for determining an elevation or gradient, since an impression of a gradient would show if the rider accelerates in a plane.

If the barometric pressure sensor for obtaining the absolute ambient air pressure is located for example in the housing of the bicycle component or in the measuring device 2, then the air stagnates in front of the housing as a consequence of the wind blast or the traveling speed and at the front tip of the housing generates a total pressure which negatively (or also positively) influences the absolute air pressure measured in the interior of the housing.

If the barometric pressure sensor for capturing the absolute air pressure is disposed on a side of the housing next to an opening, then the result again shows a negative influence due to Bernoulli's theorem. Then, the air flowing past may generate an underpressure which would again—depending on the speed—show a negative influence on the absolute pressure.

This is why correction of the air pressure signal 21 by the stagnation pressure value 26 is useful and advantageous if the bicycle component 1 is to obtain minor and also tiny gradients. The correction is in particular done together with a calibrating matrix captured in previous tests under known conditions. Calibration values are in particular captured and stored for variations of the relative speed and/or variations of the yaw angle. A correction is for example advantageous and important to sufficiently precisely obtain the air drag.

The correction of an elevation value 24 by means of an elevation signal 36 of a satellite sensor is advantageous since in circuits the bicycle component shows the same elevation at the end as at the beginning of the circuit.

Due to the relatively large graduation in measuring, an elevation profile is as a rule captured via barometric pressure sensors. However, known bicycle computers tend to show different elevation data at the beginning and the end of a circuit due to air pressure fluctuations. In fact the rider has traveled a complete round and at the end of the round he is located at precisely the same elevation as he was at the beginning of the round.

The presently disclosed combination of evaluations of satellite sensors and pressure sensors allows a very precise elevation determination and in particular a very precise determination of the gradient of a path or a track. Since the power required for driving the bicycle is considerably dependent on the acceleration, the gradient if any, the rolling resistance, and the air drag, high accuracy can thus be achieved.

The invention allows the rider to also measure and evaluate during riding, his seated position as well as the bicycle components and other equipment such as his helmet, suit, clothing etc. Thus the rider may find out what for him is the optimal seated position and combination of bicycle parts and equipment and determine what for him is e.g. the best helmet in terms of aerodynamics offering the lowest air drag in his preferred position.

Other than the options described for calibrating the barometric pressure sensor during rides, re-calibration can also be performed if the barometric pressure sensor found a specific gradient or a specific slope. For example following a gradient or a slope of 5 m or 10 m. Re-calibration can also be performed at specific time intervals. Also, a combination of calibration based on time and exceeded elevation differences may be performed.

Air pressure values are preferably measured using barometric pressure sensors showing a measuring range encompassing at least 25% and in particular at least 50% of the normal pressure of (approximately) 100 kPa. For capturing the ambient pressure or the total pressure, barometric pressure sensors are preferred showing a measuring range of higher than 30 kPa and in particular at least 50 kPa or 60 kPa or 80 kPa.

In preferred configurations the measuring range of the differential pressure sensors employed is smaller than that of the barometric pressure sensors employed. Differential pressure sensors are in particular employed for capturing the stagnation pressure and/or the yaw angles. The measuring range of a differential pressure sensor employed is preferably less than 20 kPa and in particular less than 10 kPa and particularly preferably less than 5 kPa or 2 kPa or 1 kPa. In a specific example, differential pressure sensors are used showing a measuring range of 0.5 kPa (+/−20%). This enables a high resolution and accuracy.

The measuring range of a barometric pressure sensor for capturing the ambient pressure or the total pressure is preferably larger than the measuring range of a differential pressure sensor for the stagnation pressure or for determining the yaw angle.

The ratio of the measuring range of a barometric pressure sensor for capturing the ambient pressure or the total pressure to the measuring range of a differential pressure sensor for stagnation pressure or for determining the yaw angle is preferably higher than 5:1 and in particular higher than 10:1 and particularly preferably higher than 50:1.

In all the configurations it is preferred to perform temperature compensation of the measurement values to prevent thermal effects.

The configuration of the measuring probe respectively probe body 5 is advantageous since it allows operating a bicycle independently of the external conditions. The configuration of the air guide in the interior of the probe body 5 reliably prevents any penetrating water from being conducted toward a barometric pressure sensor. And, in case that a droplet of water or dirt has in fact entered, it is retained in the takeup space 17 of a chamber 15. Thereafter the water may exit for example by evaporation, or manual cleaning, flushing and/or purging is performed after removing the probe body 5, which is in particular clipped on. The air ducts and their dimensions and the chamber(s) provide a labyrinth seal with an additional takeup space so that the measuring probe 4 is waterproof under any conditions expected in everyday use.

A conventional membrane in the interior of the measuring probe for mechanically separating the supply duct 11 from the sensor duct 12 achieves sufficient tightness as a rule. There is the drawback that accuracy is considerably reduced and the measurement results are thus deteriorated so that an aerodynamic drag coefficient cannot be determined with sufficient accuracy. The measuring probe 4 presently disclosed achieves sufficient tightness and sufficient accuracy.

Preferably the probe body 5 is manufactured by way of 3D printing, at least partially or entirely of plastic, and/or at least partially or entirely of metal. The interior may show an integral seal or labyrinth seal. 3D printing allows much greater ease of manufacturing a probe body than conventional technology does. Thus, hollow spaces may be provided in places where solid material is otherwise required for reasons of process technology.

### LIST OF REFERENCE NUMERALS

| | |
|---|---|
| 1 | bicycle component |
| 2 | measuring device |
| 3 | housing |
| 4 | measuring probe |
| 5 | probe body |
| 6 | opening in 5 |
| 6a | opening |
| 7 | opening |
| 8 | dimension of 5 |
| 10 | air guide |
| 11 | air duct, supply duct |
| 12 | air duct, sensor duct |
| 13 | air duct, intermediate duct |
| 14 | labyrinth seal |
| 15 | chamber |
| 15a | chamber section |
| 15b | chamber section |
| 15c | partition wall |
| 15d | connecting opening |
| 16 | chamber |
| 17 | takeup space in 15, 16 |
| 18 | water |
| 19 | cross section of 11-13 |
| 20 | barometric pressure sensor, absolute pressure transducer |
| 21 | air pressure signal of 20, sensor value of 20 |
| 22 | corrected ambient pressure value |
| 23 | measure of elevation |
| 24 | elevation value |
| 25 | stagnation pressure sensor system, pitot sensor |
| 25c | differential pressure sensor |
| 26 | stagnation pressure value, sensor value of 25 |
| 27 | change of elevation |
| 28 | reference signal |
| 30 | yaw sensor system |
| 30a | opening |
| 30b | opening |
| 30c | differential pressure sensor |
| 32 | yaw angle |
| 33 | relative wind direction and wind force |
| 34 | traveling speed |
| 35 | satellite sensor |
| 36 | elevation signal |
| 37 | humidity sensor |
| 38 | acceleration sensor |
| 40 | control device |
| 41 | first measuring curve |
| 42 | second measuring curve |
| 43 | third measuring curve |
| 50 | computer |
| 51 | memory |
| 52 | data interface, network interface |
| 53 | calibration data |
| 54 | energy source |
| 100 | bicycle |
| 101 | wheel, front wheel |
| 102 | wheel, rear wheel |
| 103 | frame |
| 104 | fork, suspension fork |
| 106 | handlebar |
| 107 | saddle |
| 109 | spoke |
| 110 | rim |
| 112 | pedal crank |
| 115 | speed sensor |
| 116 | power sensor, force sensor |
| 120 | elevation |
| 200 | path |
| 201 | gradient value, gradient angle |
| 202 | elevation curve |
| 300 | satellite system |
| 301 | satellite |

1. Method of determining performance data by capturing and evaluating sensor data while riding an at least partially muscle-powered bicycle (100) on a path (200), having at least two sensors (20, 35), wherein at least air pressure signals (21) are captured, and wherein the following steps are carried out:
capturing at least one current air pressure signal (21) for the ambient pressure, by at least one barometric pressure sensor (20), and deriving a current measure of elevation (23);
determining a current gradient value (201) of the path (200) from the captured air pressure signals (21);
capturing track data and determining the current speed value;
obtaining performance data from the current gradient value (201) and the current speed value.

2. The method according to any of the preceding claims, wherein the current air pressure signal (21) is periodically captured at a frequency of higher than 10 Hz.

3. The method according to any of the preceding claims, wherein an air pressure signal (21) is obtained from a plurality of measurement values picked up by the barometric pressure sensor, and wherein measurement values picked up by the barometric pressure sensor (20) are filtered, and an air pressure signal (21) is derived from the filtered measurement values.

4. The method according to any of the preceding claims, wherein at least one acceleration value is derived.

5. The method according to any of the preceding claims, wherein at least one current elevation signal (36) is derived by way of capturing data from a satellite system (300), and wherein a current elevation value (24) is derived from the current air pressure signal (21), taking into account the current elevation signal (36).

6. The method according to any of the preceding claims, wherein interference signals (29), such as disturbances caused by passing vehicles or wind gusts, are filtered out.

7. The method according to any of the preceding claims, wherein at least one aerodynamic drag coefficient is derived.

8. The method according to any of the three preceding claims, wherein the frequency for capturing the air pressure signals (21) by the barometric pressure sensor (20) is higher than the frequency for capturing the elevation signals (36) from the satellite system (300).

9. The method according to any of the four preceding claims, wherein the capturing times of the air pressure signal (21) and of the elevation signal (36) for deriving an elevation value (24) are matched to one another and/or synchronized.

10. The method according to any of the preceding claims, wherein at least one measuring frequency for capturing signals is variably set by a control device (40).

11. The method according to the preceding claim, wherein the measuring frequency is set in dependence on at least one current riding condition.

12. The method according to any of the preceding claims, wherein the frequency for deriving an elevation value (24) is dependent on the traveling speed of the bicycle (100) and increases along with the traveling speed increasing, or wherein the frequency for deriving an elevation value (24) is dependent on the gradient (201) of the path (200) and/or the acceleration.

13. Bicycle component (1) with a control device (40) and a measuring device (2) for determining performance data by way of capturing and evaluating sensor data when riding an at least partially muscle-powered bicycle (100) on a path (200), with at least two sensors (20, 35), wherein at least one barometric pressure sensor (20) for capturing a characteristic current air pressure signal (21) is comprised, and wherein a computer (50) is comprised which is configured and set up to determine from the captured air pressure signals (21) a current gradient value (201) of the path (200), and to capture track data to determine therefrom a current speed value, and to obtain performance data from the current gradient value (201) and the current speed.
